(19) United States
(12) Patent Application Publication
(10) Pub. No.: US 2010/0125490 A1
(43) Pub. Date: May 20, 2010

(54) SOCIAL NETWORK REFERRAL COUPONS

(75) Inventors: Emre Mehmet Kiciman, Seattle, WA (US); Darko Kirovski, Kirkland, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/270,974

(22) Filed: Nov. 14, 2008

(51) Int. Cl. G06Q 30/00

(52) U.S. Cl. 705/14.1

(57) ABSTRACT

The claimed subject matter provides a system and/or a method that facilitates enhancing coupon distribution in a non-evasive manner based upon a referral. A social network can include two or more users with at least one actively acknowledged connection that indicates a relationship between a first user and a second user. An interface can receive a referral from the first user associated with the social network, wherein the referral describes an experience related to at least one of a business or a service. A viral coupon component can implement a non-evasive delivery of a coupon to the second user based upon leveraging the relationship between the first user and the second user, wherein the coupon is incorporated within at least one of an advertisement or a listing. The vial coupon component delivery of the coupon can be triggered based upon the second user actively investigating at least one of the business or the service.

### BACKGROUND

The emergence of global communication networks such as the Internet and major cellular networks has precipitated interaction between users and other network entities. Not only are cellular and IP networks now a principal form of communications, but also a central means for interacting with other users for most purposes. Network users now have mechanisms for searching and communicating (or socializing) on virtually any topic of interest. However, this vast resource of information can also be an impediment to finding information as it continues to grow with no end in sight. This presents a formidable challenge when trying to find the information desired or other users who have similar points of interest.

One such network entity that provides social interaction around common subjects is the social network. Social network theory focuses on the relationships and links between individuals or groups of individuals within the network, rather than the attributes of individuals or entities. Smaller, stronger networks can be less useful to network individuals than networks with many weak links to individuals outside the main network. Generally, a social network can be described as a structure of nodes that represent individuals or groups of individuals (e.g., organizations). Social networking can also refer to a category of network applications that facilitate connecting friends, business partners, or other entities or groups of entities together.

Social networks with many weak links and social connections are more likely to provide new ideas and opportunities to the network individuals or groups than relatively closed networks that can have many redundant links such as in a group of individuals who routinely interact, and may already share the same knowledge and opportunities. Accordingly, individuals or groups of individuals of the social network having connections to other social entities are more likely to have access to a wider range of different information. Thus, social networks can function as a source of information that is more relevant to what a user may want. Moreover, social networks can provide a gateway to various avenues of information from trusted sources since such connections within the social network are established by a user actively which inherently establishes such sense of trust.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate leveraging a pre-existing relationship from a social network in order to provide non-evasive coupons. A viral coupon component can deliver a universal coupon for a business or service to a user in a non-evasive manner based upon a pre-established relationship or connection with a disparate user within a social network. In particular, a first user, having a connection or relationship with a second user within a social network, can submit a referral for a business or service. A coupon delivery to the second user can be triggered by a search or result listing that includes the business or service. In other words, the coupon can be provided to the second user based upon the relationship or connection with the first person within the social network and/or the search, query, or result listing that includes such business or service. Upon redemption of the coupon, the viral coupon component can distribute a referral bonus or reward to the first user. In general, the viral coupon component can allow users to receive coupons that fulfill or satisfy searches or queries.

In accordance with another aspect of the subject innovation, the viral coupon component can employ a universal coupon that can be utilized in an online environment, an offline environment, and/or any suitable combination thereof. The universal coupon can include security and/or authentication measures in order to reduce fraudulent use. The universal coupon can be printed and redeemed in the physical real world. In addition, the universal coupon can be an electronic coupon that can be redeemed online. In still another example, the universal coupon can be communicated to a device (e.g., machine, computer, smartphone, cellular device, portable digital assistant (PDA), gaming device, mobile gaming device, media player, portable media device, mobile device, etc.), in which such device can facilitate mobile redemption. In other aspects of the claimed subject matter, methods are provided that facilitate associating a coupon with an advertisement or listing based upon a referral from a user related to a social network or an aggregation site.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates leveraging a pre-existing relationship from a social network in order to provide non-evasive coupons.

FIG. 2 illustrates a block diagram of an exemplary system that facilitates utilizing a social network or an aggregation site to distribute a coupon based upon a referral.

FIG. 3 illustrates a block diagram of an exemplary system that facilitates receiving a referral and distributing a coupon between two or more users associated within a social network.

FIG. 4 illustrates a block diagram of an exemplary system that facilitates associating a coupon with an advertisement or listing based upon a referral from a user related to a social network or an aggregation site.

FIG. 5 illustrates a block diagram of exemplary system that facilitates enhancing security with user data in accordance with the subject innovation.

FIG. 6 illustrates a block diagram of an exemplary system that facilitates automatically distributing coupons between two or more users with an established relationship within a social network.

FIG. 7 illustrates an exemplary methodology for leveraging a pre-existing relationship from a social network in order to provide non-evasive coupons.

FIG. 8 illustrates an exemplary methodology that facilitates utilizing a social network or an aggregation site to distribute a coupon based upon a referral.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “publisher,” “distributor,” “aggregator,” “service,” “site,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

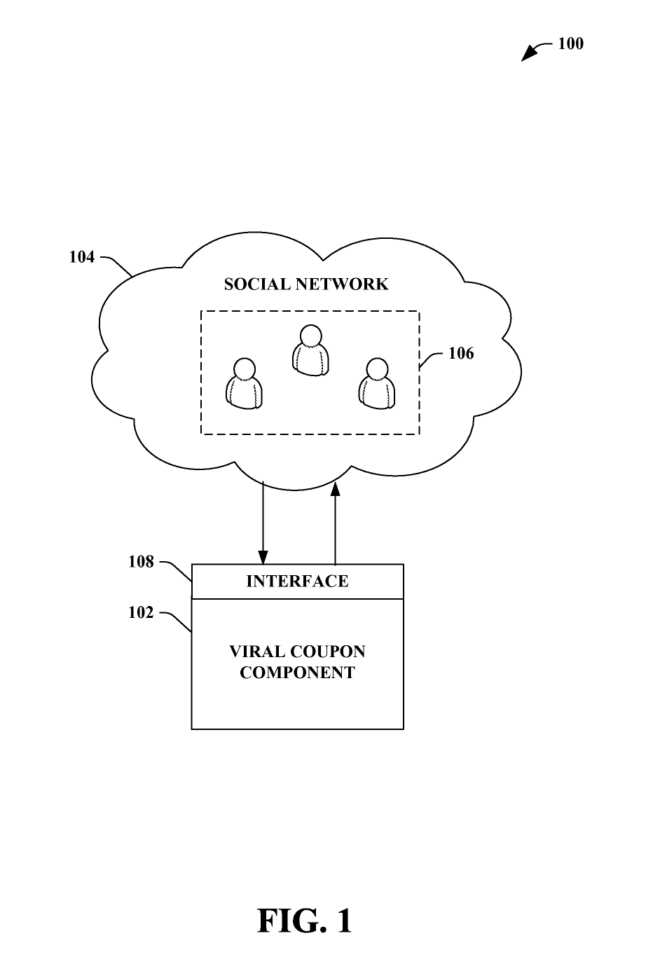

Now turning to the figures, FIG. 1 illustrates a system 100 that facilitates leveraging a pre-existing relationship from a social network in order to provide non-evasive coupons. The system 100 can include a viral coupon component 102 that can automatically incorporate a coupon (e.g., also referred to as a universal coupon discussed in more detail below) within an advertisement or a listing for a business or service based upon a referral from a user. In particular, the viral coupon component 102 can implement a non-evasive delivery of the coupon to a user by leveraging a relationship established within a social network 104. The social network 104 can include two or more users 106 in which each user can have respective connections that represent relationships between one another. In general, the viral coupon component 102 can leverage an actively acknowledged relationship between two users in order to deliver a coupon based upon a referral from at least one of the two users. In other words, a first user within the social network 104 can submit a referral for a business or service and a coupon can be linked to such business or service for communication to links, connections, or relationships to such first user on the social network 104. Specifically, a second user can receive the coupon in a non-evasive manner based upon an active pursuit or search associated with the business or service to which the referral is targeted. Additionally, the first user can be provided with a reward or bonus for submitting a referral.

For example, a social network can include graphical representations of users. Within the social network, each user can have relationships or connections to other users as well as information or personal data. The connections, relationships, and ties between users can be ascertained based upon an active acceptance from a user, wherein the active acceptance can be a confirmation of a notification for a request for such connection, relationship, or tie. For example, a first user can browse the graphical representations to identify a potential “friend,” in which a friend can be substantially similar to a physical real world friend. In other words, the friend is a distinction for a connection, relationship, or tie. Once located, the first user can communicate a request to the potential friend, in which such request can be actively accepted for the relationship to be established. Based upon such active acceptance and knowledge of the relationship, users within the social network are consciously aware of the users listed as friends. It is to be appreciated that each specific user can include a plurality of friends or relationships and such depiction of a single user with a group of friends is not to be limiting on the subject innovation. It is also to be appreciated that the social network 104 can include instant messaging applications, social networking websites, address books, social networking web page, communication application (e.g., video communicator, audio communicator, etc.), messaging application, a forum, an online community and/or any other suitable online interaction that includes a listing of friends that have been actively approved and accepted.

For instance, a social network can include a user named Bob who has friends named Sally, Mary, and Greg. Bob can have relationships established within the social network that correlate to real world relationships in that Bob is connected or linked to Sally, Mary, and Greg as he is friends with such people in the real world. Based on an experience, Bob can submit a referral for a business or service. Based on such referral and the social network relationship, if Sally, Mary, or Greg actively pursue or search for the business or service, a coupon can be incorporated into the advertisement or listing. In other words, since Bob provided a referral and one of his friends or links from the social network are actively searching or pursuing such business or service, a coupon can be presented to the friend(s). For example, Mary can utilize a search engine for a Chilean restaurant in which one of the results can include a coupon, wherein the coupon can be available based upon Bob's referral. If Mary commences a purchase from the business or service, the referrer (here Bob) can receive a referral bonus or credit. In this manner, the referral, coupon, and referral bonus or credit is non-evasive or intrusive on any of the individuals.

In addition, the system 100 can include any suitable and/or necessary interface component 108 (herein referred to as the interface 108), which provides various adapters, connectors, channels, communication paths, etc. to integrate the viral coupon component 102 into virtually any operating and/or database system(s) and/or with one another. In addition, the interface 108 can provide various adapters, connectors, channels, communication paths, etc., that provide for interaction with the viral coupon component 102, the social network 104, the two or more users 106, and/or any other device and/or component associated with the system 100.

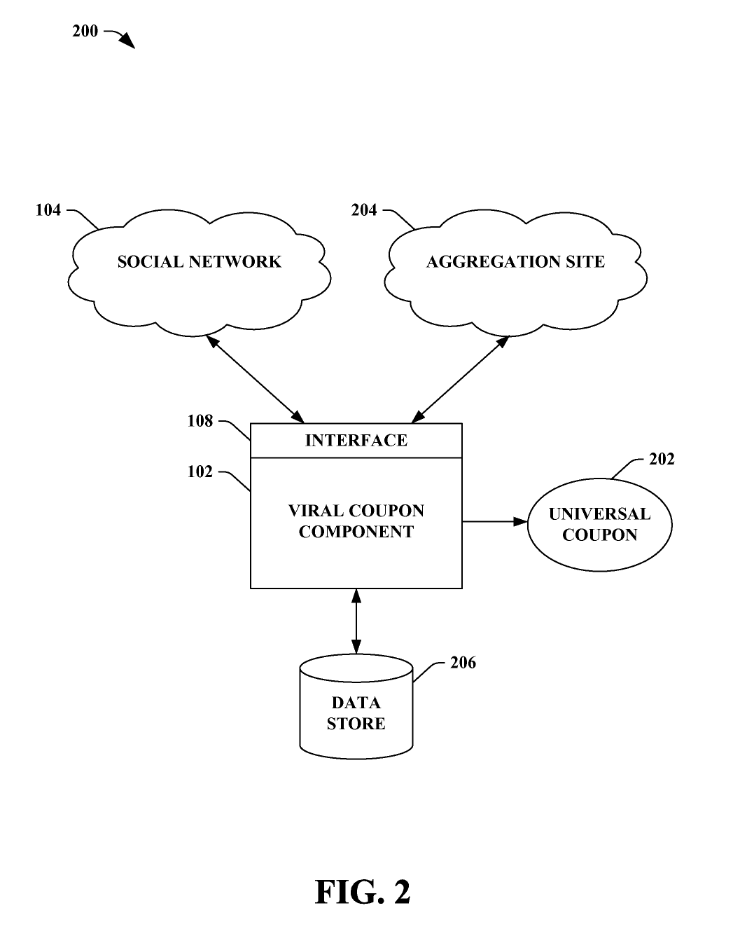

FIG. 2 illustrates a system 200 that facilitates utilizing a social network or an aggregation site to distribute a coupon based upon a referral. The viral coupon component 102 can integrate word-of-mouth referrals with online advertising networks in order to improve efficacy of advertising by associated the endorsements of friends with online advertisements. The viral coupon component 102 can provide a discount and/or bonus coupon (e.g., a universal coupon 202) that encourages users (e.g., a referrer) to refer merchants, products, and/or services to their friends (e.g., a consumer) by allowing both the consumer to receive a discount and the referrer to receive a referral bonus or credit. Moreover, the viral coupon component 102 can enable consumers to receive such coupons in a non-evasive and non-intrusive manner since the coupons are integrated into advertisements or listings of businesses or services to which the consumer has been investigating. In other words, such coupon exposure can be predicated from the relationship between the referrer and such consumer in the social network 104.

The viral coupon component 102 utilizes the universal coupon 202 that can be utilized online, offline, or any suitable combination thereof. The universal coupon 202 can be a printable coupon that can bridge the online advertisement with offline services and products. In general, the universal coupon 202 can enable the charge-per-action model of advertisement to be extended from online transactions to offline transactions. For instance, the universal coupon 202, which can be delivered to a recipient in a non-evasive manner, can be utilized as an electronic coupon online with a business or service. In another example, the universal coupon 202 can be printed or utilized offline as a physical coupon (e.g., printed, reference code, etc.). For example, the physically printed out coupon can be utilized in a physical store, wherein the physical store can include any suitable services (e.g., landscaping, manual labor, home improvements, snow removal, milk delivery, movie delivery, etc.) delivered on-site or businesses/services regardless of having a “bricks & mortar” storefront. In still another example, the universal coupon 202 can provide a discount for an online purchase and also physically presented on pick-up for the purchase for a disparate or additional discount. It is to be appreciated that the coupon 202 can be utilized in any suitable situation associated with a business or a service in an online manner and/or an offline manner. Moreover, it is to be appreciated that the universal coupon 202 can be any suitable discount, credit, or incentive (e.g., portion of free goods, portion of free service, gifts, items, etc.) for an entity (e.g., a web entity, a recommendation engine, user, business, group of users, corporation, enterprise, machine, website, partnership, etc.) to make a purchase at such business or service.

For example, two or more users can be entities (e.g., a web entity, a recommendation engine, user, business, group of users, corporation, enterprise, machine, website, partnership, etc.), wherein the first user (e.g., the referrer) can be another user or a web entity such as a recommendation engine (e.g., a web site or service that provides recommendations based on received queries, etc.). In addition, the second user can filter out what time of offers he or she wants (e.g., friends, recommendation engine results, etc. with coupons filtered by dollar amount, etc.).

The viral coupon component 102 can further leverage an aggregation site 204 in order to deliver coupons, provide referral bonuses, non-evasively incorporate coupons, etc. The aggregation site 204 can be any suitable platform, environment, web site, web service, and the like that collects user reviews or opinions on businesses or services. For example, the aggregation site 204 can collect user opinions or reviews and based on such contributions, coupons can be distributed in accordance with such contributing user's preferences. It is to be appreciated that each aggregation site 204 can include specific user preferences on whether to opt in or opt out of the coupon distribution. In another example, the aggregation site 204 can leverage the connections associated with between each users in order to provide coupons in a non-evasive manner as described above.

In accordance with an aspect of the subject innovation, the viral coupon component 102 can track and/or monitor referrals, coupon distribution, coupon redemption, referral bonuses or rewards, and the like. In one example, a user within the social network 104 can view or search referrals for other users. Thus, a user can examine whether or not a friend or connection has any referrals for a particular business or service. If a referral for a particular business or service interests the user, the universal coupon 202 can be populated within such listing or advertisement of the business or service.

The system 200 can combine social networking information, user referrals of products and/or services, and an online offline coupon. A first user can state a preference or a referral for a product or service. The referrals can be aggregated and combined with the first user's social network information. Friends of the first user may, based on context, be shown advertisements for the products and/or services referred by their friend together with the friend's endorsement. The advertisement can include (e.g., directly, indirectly, etc.) a coupon that the user may print or electronically provide to a merchant for their service or product. Based on this coupon, the consumer and the referrer can be rewarded. In another aspect, the system 200 can be paid for the transaction. The system 200 can further provide the user of social network 104 information to display product and/or service endorsements from friends across a wide-area web advertising platform. The use of a coupon for tracking offline transactions for giving referral bonuses to users can also be provided. In addition, the use of existing review sites and/or aggregation sites 204 (e.g., search engines, online merchant sites, local business search engines, product/service search engines that provide various vendors, etc.) to generate endorsements.

The system 200 can further include a data store 206 that can include any suitable data utilized and/or accessed by the viral coupon component 102, the social network 104, the aggregation site 204, the interface 108, etc. For example, the data store 206 can include, but not limited to including, referral listings, recommendation lists, coupons, coupon user listings (e.g., consumer listings), advertisements, social network data (e.g., friends, relationships, links, connections, user settings, etc.), ad publisher information, merchant data, referrals, privacy settings, aggregation site personal preferences, delivery options, coupon options, coupon type preference, etc. Moreover, although the data store 206 is depicted as a stand-alone component, it is to be appreciated that the data store 206 can be a stand-alone component, incorporated into the viral coupon component 102, the social network 104, the aggregation site 204, and/or any suitable combination thereof.

It is to be appreciated that the data store 206 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 206 of the subject systems and methods is intended to comprise, without being limited to, these and any other suitable types of memory. In addition, it is to be appreciated that the data store 206 can be a server, a database, a hard drive, a pen drive, an external hard drive, a portable hard drive, and the like.

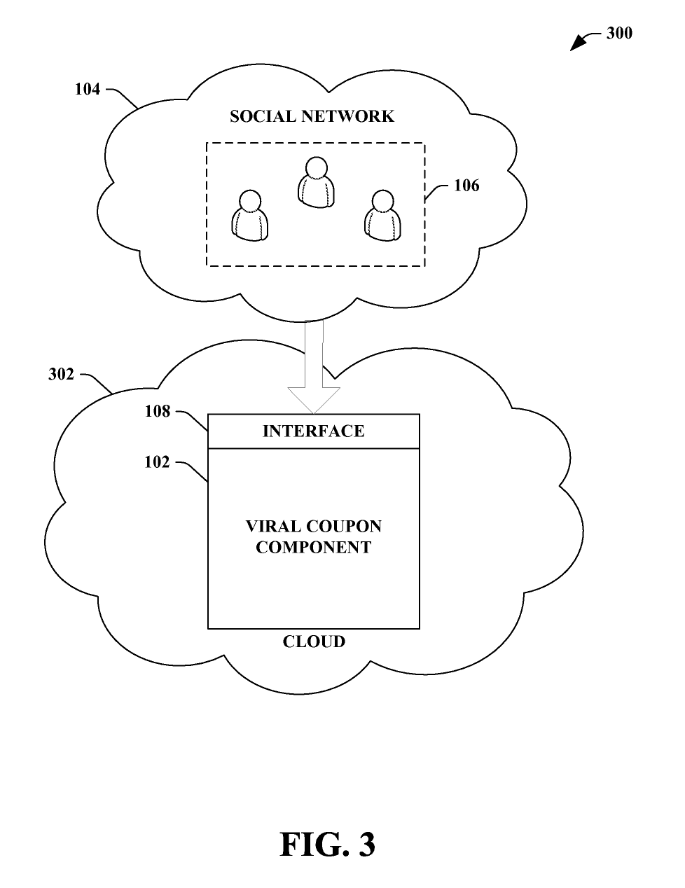

FIG. 3 illustrates a system 300 that facilitates receiving a referral and distributing a coupon between two or more users associated within a social network. The system 300 can utilize a cloud 302 that can incorporate at least one of the viral coupon component 102, the social network 104, the two or more users 106, the interface 108, and/or any suitable combination thereof. It is to be appreciated that the cloud 302 can include any suitable component, device, hardware, and/or software associated with the subject innovation. The cloud 302 can refer to any collection of resources (e.g., hardware, software, combination thereof, etc.) that are maintained by a party (e.g., off-site, on-site, third party, etc.) and accessible by an identified user over a network (e.g., Internet, wireless, LAN, cellular, Wi-Fi, WAN, etc.). The cloud 302 is intended to include any service, network service, cloud service, collection of resources, etc. and can be accessed by an identified user via a network. For instance, two or more users can access, join, and/or interact with the cloud 302 and, in turn, at least one of the viral coupon component 102, the social network 104, the two or more users 106, the interface 108, and/or any suitable combination thereof. In addition, the cloud 302 can provide any suitable number of service(s) to any suitable number of user(s) and/or client(s). In particular, the cloud 302 can include resources and/or services that can associate a coupon with an advertisement or listing for a business or service based upon a referral

Generally, the cloud 302 can provide a communications environment or network for any suitable number of users associated with the social network 104 or a plurality of social networks 104. In other words, the cloud 302 can be a secure and informative community or forum in which users can submit, share, and/or receive coupons, referrals, referral bonuses or rewards, etc. Moreover, as a forum, the cloud 302 can enable two or more users 302 to communicate (e.g., text, chat, video, audio, instant message, etc.) in relation to coupon distribution, business or service communication, connection to connection communication, etc. In addition, the cloud 302 can implement an administrator that can monitor, regulate, and/or provide assistance in relation to users and/or activity. For instance, the cloud 302 can be a networked community, a forum, and the like.

The system 300 can be an on-line platform for coupons that expands the notion of a traditional Web coupon by mimicking referral coupons in the physical real world. The social network 104 can be employed to assemble a referral system that interects users as users browse data for businesses, products, or services and offers friends' recommendations and accompanying available viral coupons.

The system 300 can include a user that can specify her “recommended list” of products and services in an arbitrary fashion (e.g., explicit data entry, “favorite” button in a browser toolbar, personalized search result reordering, etc.) with a data or web repository. When a friend of this user browses data (e.g., the Web, a network, the Internet, etc.) for businesses, products, or services, the surfed content can get marked, emphasized, reordered, or changed in arbitrary fashion to display user's friends' recommendations. For example, this alteration can be done by a client-resident engine, a client-executed script, or a server-executed script. In one example, each recommendation can be accompanied by a viral coupon in the form of an image that could be printed out or stored on any suitable device (e.g., a machine, a computer, a smartphone, a cellular device, a portable digital assistant (PDA), a gaming device, a mobile gaming device, a media player, a portable media device, a mobile device, a non-electronic device, a credit card, an identification card, a gift card, a card including a chip, or a card having a magnetic strip, etc.). The image can include a human and/or machine-readable identifier that could be used as a pointer to a trusted Web site that can verify coupon offers and resolve disputes. These coupons can also be Web coupons in which case such coupons can be presented to the merchant electronically for pay-per-action marketing. Most importantly, the “friends” information can be extracted from at least one of the social network 104, e-mail or messaging database, or obtained explicitly from users.

The following entities can be distinguished in the system 300: an advertiser, a referrer, a consumer, a social network provider, a coupon publisher, and a viral coupon manager. Advertiser (x) can be an entity that financially backs a viral offer to the public. An advertiser can be—indirect—an agency paid to carry a marketing campaign on behalf of a third party, or—direct—any merchant, service provider, or manufacturer, with an interest in encouraging a transaction to occur. It is to be appreciated that x can represent the off/on-line store/service provider where consumers redeem coupons for merchandise/service. In real-life scenarios, x can model more than one economic entity. Referrer (r) can be a user endorsing or recommending a product or service using client-or server-side tools. The referrer can be given an incentive as part of the viral coupon on tract to propagate her/his recommendations to friends. Consumer (c) can be a friend of r and a non-infected target of the viral offer. Social Network Provider (f) can be a service that quantifies and qualifies social relationships between referrers and consumers (e.g., an email service provider, a messenger application, a social network, a business social network, etc.). Coupon Publisher (p) can feed a page (e.g., a Web page, a data page, a portion of data, etc.) to c; c can be served a viral coupon augmented in such page—this entity can play a marginal role in certain implementations of viral coupons. Viral Coupon Manager (m) can be a service (e.g., a web service, etc.) that manages the flow of information required to enable viral coupons. For example, the viral coupon manager can connect social networks, advertisers, referrers, consumers, and ad publishers to support the proposed marketing platform. The viral coupon manager can (i) provide recommendation aggregation from referrers, (ii) provide coupon distribution to consumers based upon the underlying social network and consumer interest, and (iii) provide traffic measurements to enforce pay-per-click or pay-per-action marketing.

The viral coupon can be an arbitrary user interface that emphasizes a recommendation by a c's friend, r, for a specific economic opportunity (e.g., business, product, service, item, good, etc.). For example, by activating the user interface (e.g., by clicking onto a link), the viral coupon can be presented to c as an image that entails: (i) graphics presenting the offer: O≡{c, r, x, and the economic details}; and (ii) a human-and/or machine-readable coupon identifier, d. The consumer can print the coupon or store it onto a device in order to presents it to x. In an on-line version of the protocol, c can redeem O as a Web coupon.

The following is an example to emphasize particular aspects of the subject innovation and are not to be limiting on the claimed subject matter. In an example for signing up advertisers, the following can be employed. A restaurant (x) can approach m with a viral offer where a pay-per-action budget of $22 can be divided as $10 to c and p each and $2 for m (e.g., m's revenue before sharing). The recommendation aggregation can include r, a member of f and a frequent customer of x's. r can enter a recommendation for x via an arbitrary interface, which can get recorded with m. To complete this task, m can utilize access to (e.g., a pointer to) r's identity from f. Numerous implementations can be utilized for this task that can provide varying degrees of support from f. At the time of recommending x, r can learn financial details of the viral offer. The marketing can be triggered in the following example. A friend of r's, named c can browse data (e.g., search engine, the web, the Internet, search results, etc.) in search of a good restaurant. This action can be detected by a tool that can reside on either c's or p's computers or machines, where p is can be a server (e.g., a web server) that provides a page with related content to c, (e.g., a search engine, a portal, a recommendation engine, a blog, etc.). The detection tool can be, for example, keyword-based or defined using more sophisticated techniques which aim at modeling user behavior on the Web. In case of a positive result, the tool can notify m that there is an opportunity for presenting a viral offer. If p triggers the marketing signal, m can offer to split its revenues with p-p can provide added value by accurately adjusting the topic of interest. The message sent to m can include of (e.g., a pointer to) c's identity with f and a product/service name. The following can be an example of coupon distribution. m can look up c's friends with f, retrieve their recommendation lists, and present c with a related viral coupon O {c, r, x,$10 discount}. This coupon can be presented to c using an arbitrary interface (e.g., a click-to-expand interface with r's photo, a pointer to a review, offered discount value, etc.). To take the benefit of this offer, c can decide to store it in her device as an image, visit x and demand exercise of the offer. Now, x can fulfill its promise with respect to c directly and in good faith with respect to r (e.g., via a store credit, gift card, rebate coupon, etc.). The system 300 can be implemented with a pay-per-click model (e.g., upon instances when a coupon is presented to a consumer, m could charge x a fixed or an auctioned fee). In one implementation of a pay-per-action model, m would rely on x's goodwill, together with any contractual obligations, to report conversions. In this implementation, there can be a risk of errors or omissions in reporting conversions. The pay-per action model can also provide an easy-to-use reporting system, or use a reliable and trusted third-party communication channel, such as a bank or credit-card company, to automatically report conversions to m.

A potential dispute between x and c can be resolved by looking up the coupon contract using d as a pointer into y's on-line contract database. In order to prevent privacy problems, contract identifiers can be random points (e.g., a random 128-bit number, etc.) drawn from a large space (e.g., 2128). In order to support off-line verification of viral coupons, y can cryptographically (e.g., elliptic curve cryptography, public key, digital signatures, etc.) sign the offer, O, and print the signature onto the viral coupon as, for instance, a barcode. A verifier with only the public key of y can then be able to scan and optically character recognize (OCR) the text of the offer, extract the signature from the barcode, and verify the authenticity of the coupon.

The social network S≡G(V, E) can be described as an undirected graph where each node, v(i)∈V , can correspond to a member of the network, and an edge e (i,j)∈E corresponds to a “friendship” relation between two users, v(i)and v(j). A tier-K entourage, F (i) can be defined of node v(i) as a subset of nodes from V-v(i) which can be at minimal distance of at least K hops from v(i). For a specific viral coupon, K can be defined by either x or c or an individual node in F (c). Note that S is either a part of or imported into y's services by c.

It is to be appreciated that there can be various ways on how viral coupons can be integrated into consumer's browsing. For example, a specific user in the system, c, can specify her recommendation list, L, using an arbitrary interface and set up an account with y to make L public to her F (c). Merchants from L that offer viral coupons can than be emphasized during browsing for each participant in F (c). For example, if c searches for a service (e.g., a restaurant) with some geographical constraint, then y can offer an additional group of links such as, but not limited to, “restaurants recommended by friends,” or re-rank search results or directory lists based upon the L-lists by F (c) as a final result to the query.

Moreover, emphasis of Web-page content as a precursor for displaying viral coupons can be implemented on the server side while a user from F (c) browses the Web pages constructed by y, or it can be done by a client agent for a portion of Web pages browsed by c∈F (c). In the first case, the server can store user recommendation lists and S, while in the latter case a specific client agent can store locally the recommendation lists of each friend in F (c).

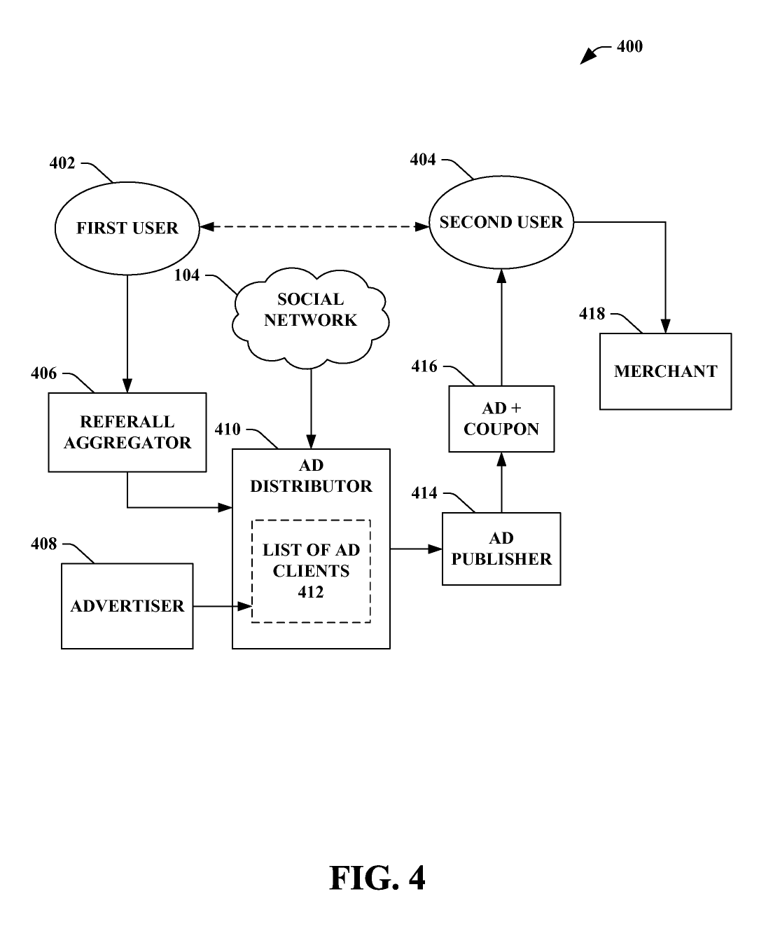

FIG. 4 illustrates a system 400 that facilitates associating a coupon with an advertisement or listing based upon a referral from a user related to a social network or an aggregation site. The system 400 can include a first user 402 (e.g., a referrer) and a second user 404 (e.g., a consumer) that include a connection or relationship (e.g., illustrated with a dotted double-arrow) within the social network 104. The system 400 can be a particular example in which coupons can be delivered to users in a non-evasive manner, wherein active pursuit or search of a business or service triggers coupon delivery from such business or service referred to by a friend within the social network 104. In general, it is to be appreciated that the system 400 is one of many potential systems that can implement the subject innovation and the following example is not to be limiting on the claimed subject matter.

The system 400 can include the first user 402 that submits a referral to a referral aggregator 406 that collects and/or stores such referrals. The referral can be any suitable review, posting, information, user opinion, a portion of audio, a portion of text, a portion of video, a portion of blog, a critique, or a portion of a graphic in connection with at least one of a business, service, or product. For example, the referral aggregator 406 can be a search engine, a web site, a shopping website that includes various vendors or products, a product price finder engine, a local search engine, etc. The referral aggregator 406 can communicate such information to an ad distributor 410 which can include a list of ad clients 412. In addition, an advertiser 408 can register or sign up for the ad service depicted herein. The social network 104 can interact with the ad distributor 410 in order to allow the leveraging of any relationships or connections (e.g., “friends”) of a specific user. It is to be appreciated that the social network 104 can include instant messaging applications, social networking websites, address books, and/or any other suitable online interaction that includes a listing of friends that have been actively approved and accepted.

For example, the system 400 can allow the active investigation of at least one of the business or the service with at least one of a search engine, a search site, a web site, the Internet, a local search engine, a review site, an aggregation site, a product search site, a shopping website that includes a vendor, a shopping website that includes a product, an article, a newspaper, a book, a magazine, a customized portion of print, a customized portion of media, an on-demand book printing, a portion of embedded user-specific advertisement, or a product price finder engine. For example, the coupon can be embedded into customized hard copies specific to a user and/or delivered in soft copies to a user.

The ad distributor 410 can provide the list of ad clients 412 to an ad publisher 414 that can generate an ad+coupon 416. It is to be appreciated that the ad publisher 414 can be a search engine, a web site, etc. Such ad+coupon 416 can be delivered to the second user 404 based upon an active search or pursuit for information about the service or business to which the first user 402 provided a referral. The second user 404 can purchase from the business or service (e.g., an item, a good, a service, etc.) with the coupon from a merchant 418 related to such business or service. The merchant 418 can notify the ad distributor 410 of the transaction. Moreover, the merchant 418 can provide a referral bonus or reward to the first user 402. In addition, cost per action (CPA) can be collected from the advertiser 408. Furthermore, although the viral coupon component 102 is not depicted in the system 400, it is to be appreciated that the referral aggregator 406, the advertiser 408, the ad distributor 410, the list of ad clients 412, the ad+coupon 416, the ad publisher 414, and/or the merchant 418 can be stand alone components, incorporated into the viral coupon component 102, and/or any suitable combination thereof.

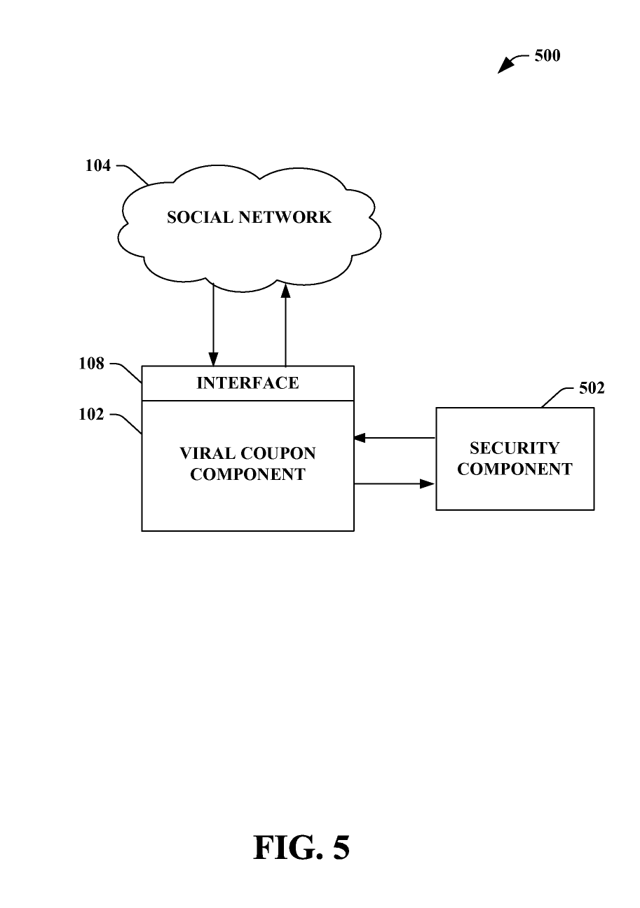

FIG. 5 illustrates a system 500 that facilitates enhancing security with user data in accordance with the subject innovation. The system 500 can include a security component 502. In one aspect, the security component 502 can allow a user to opt in of data gathering, opt out of data gathering, etc., wherein data gathering can be related to collection of user data, social network data, purchase data, referral data, and/or any suitable combination thereof. In another example, the security component 502 can provide notice of data collection as well as providing the opportunity for an entity (e.g., user, group of users, business, home, family, enterprise, company, etc.) to provide consent, deny consent, provide user-specific consent on a per-item basis, etc. Moreover, the security component 502 can allow user access and management of any suitable data collected and/or data collection settings. For example, the user can edit/view data collections settings such as, type of data collected, access of collected, restrictions of data collections, etc. In general, the security component 502 can allow an entity to manage data collection preferences. In still another example, the security component 502 can secure data communications associated with personal data (e.g., private data, account information, etc.).

The security component 502 can employ granular levels of security for the various amounts and types of data collected by the system 500. For example, a first level of data collected can be assigned with a first security level and a second level of data (e.g., more sensitive in comparison to the first level of data) can be assigned with a second security level (e.g., more secure in comparison to the first security level). Additionally, the data communications utilized with the viral coupon component 102 can be protected with security techniques and/or mechanisms such as, but not limited to, passwords, usernames, cryptology, public and private keys, digital certificates, digital authentication, human interactive proofs (HIPs), etc.

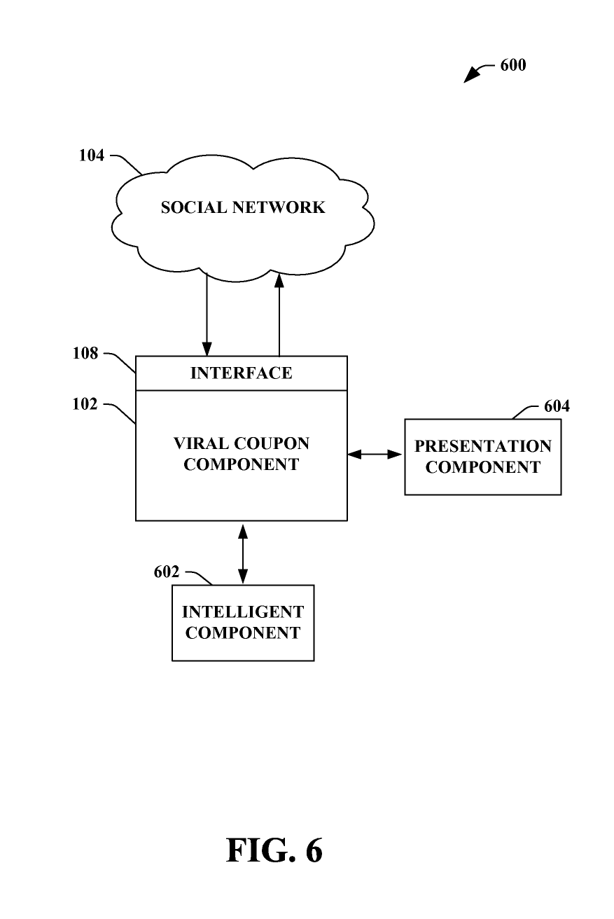

FIG. 6 illustrates a system 600 that employs intelligence to facilitate automatically distributing coupons between two or more users with an established relationship within a social network. The system 600 can include the viral coupon component 102, the social network 104, and the interface 108 which can be substantially similar to respective components, networks, and interfaces described in previous figures. The system 600 further includes an intelligent component 602. The intelligent component 602 can be utilized by the viral coupon component 102 to facilitate leveraging a pre-existing relationship from a social network in order to provide non-evasive coupons. For example, the intelligent component 602 can infer potential relationships or connection within a social network, coupon delivery preference, user privacy settings, referral confidence or accuracy (e.g., whether a user provides accurate referrals, etc.), coupon values, referral bonus or reward values, user preference for reward type, user preference for coupon preference, etc.

The intelligent component 602 can employ value of information (VOI) computation in order to identify coupons for a particular user when multiple coupons from various friends are available. For instance, by utilizing VOI computation, the most ideal and/or appropriate coupon can be determined. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The viral coupon component 102 can further utilize a presentation component 604 that provides various types of user interfaces to facilitate interaction between a user and any component coupled to the viral coupon component 102. As depicted, the presentation component 604 is a separate entity that can be utilized with the viral coupon component 102. However, it is to be appreciated that the presentation component 604 and/or similar view components can be incorporated into the viral coupon component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the viral coupon component 102.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

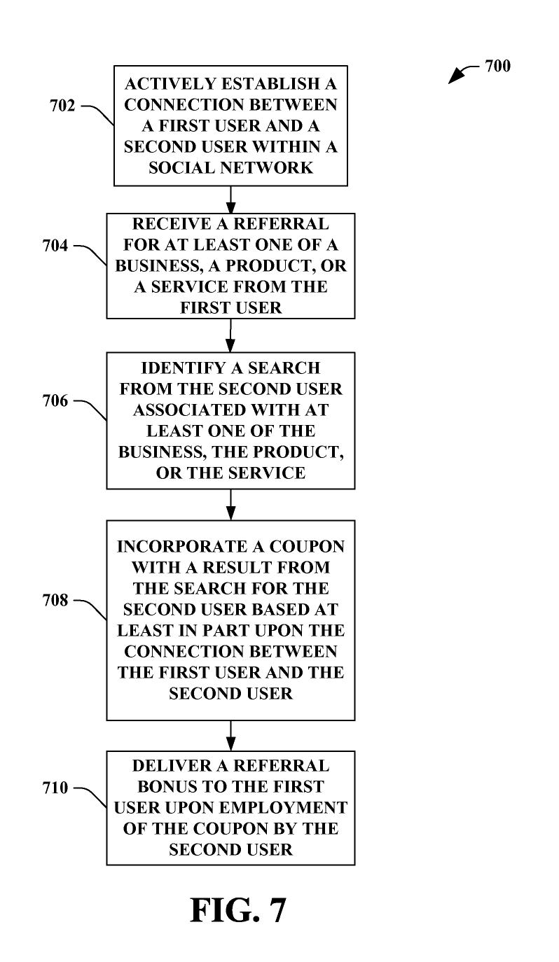

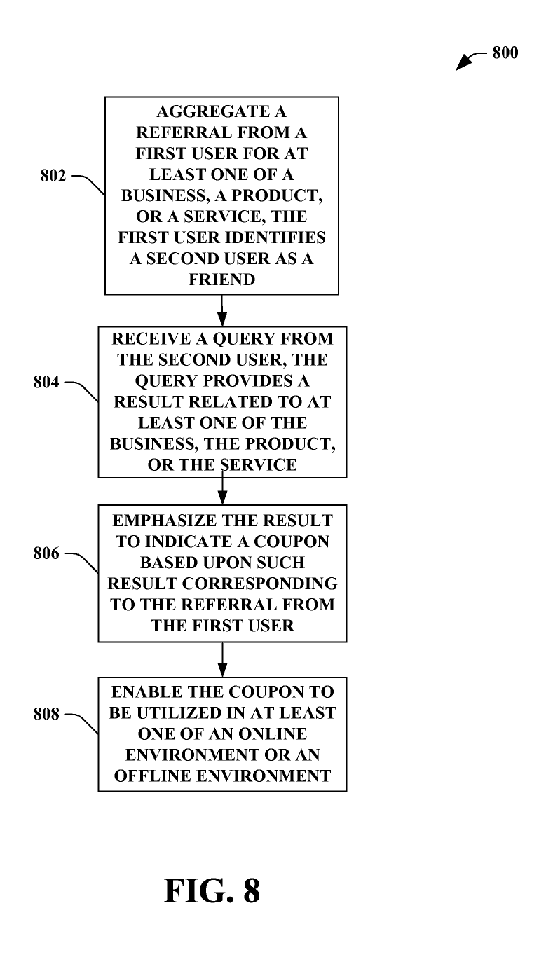

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates leveraging a pre-existing relationship from a social network in order to provide non-evasive coupons. At reference numeral 702, a connection between a first user and a second user within a social network can be actively established. In particular, the active establishment can include at least one user requesting a connection to be established and the user receiving the request actively accepting (e.g., accepting an email, clicking an accept button on an interface, etc.) such request for the connection. Moreover, there can be any suitable number of social networks with any suitable number of users with connections. For example, the subject innovation can leverage a messaging application with a friends list as well as a social networking website.

At reference numeral 704, a referral for at least one of a business, a product, or a service can be received from the first user. The referral can be any information from the first user pertaining to an experience with the business, the product, or the service. For example, the referral can be a positive review, a negative review, a descriptive post, a neutral review, etc. At reference numeral 706, a search from the second user associated with at least one of the business, product, or service can be identified. The search can be an actively pursued investigation related to the business, product, or service. By identifying such searches, this can trigger a non-evasive approach to provide the second user with information related to what he or she is querying.

At reference numeral 708, a coupon can be incorporated with a result from the search for the second user based at least in part upon the connection from the social network between the first user and the second user. As indicated above, the trigger for delivery can be the second user actively searching data related to the business, product, or service and such data corresponds to a referral made by a friend or connection within the social network. At reference numeral 710, a referral bonus can be delivered to the first user based upon the employment of the coupon by the second user.

FIG. 8 illustrates a method 800 for facilitates utilizing a social network or an aggregation site to distribute a coupon based upon a referral. At reference numeral 802, a referral from a first user for at least one of a business, a product, or a service can be aggregated, wherein the first user can identify a second user as a friend. In particular, the first user and the second user can be friends on a social network, a messaging application, a social networking site, etc. In general, the relationship between the first user and the second user can be a friend connection in which the connection is substantially similar to a real world relationship.

At reference numeral 804, a query from the second user can be received, wherein the query can provide a result related to at least one of the business, the product, or the service. For example, the second user can actively pursue a business, a product, or a service by utilizing a search engine, a web site, a local search site, a review site, an aggregation site, etc. At reference numeral 806, the result can be emphasized to indicate a coupon based upon such result corresponding to the referral from the first user. In other words, since the result corresponds to a referred (by a friend) business, product, or service, the result can be emphasized (e.g., portion of a graphic, a portion of audio, an icon, a marking, a rending, a color, a highlight, a bolding, a re-ordering, a re-positioning, etc.) to indicate such distinction.

At reference numeral 808, the coupon can be enabled to be utilized in at least one of an online environment or an offline environment. The coupon can be a printable coupon that can bridge the online advertisement with offline services and products. In general, the coupon can enable the charge-per-action model of advertisement to be extended from online transactions to offline transactions. For instance, the coupon, which can be delivered to a recipient in a non-evasive manner, can be utilized as an electronic coupon online with a business or service. In another example, the coupon can be printed or utilized offline as a physical coupon (e.g., printed, reference code, etc.).

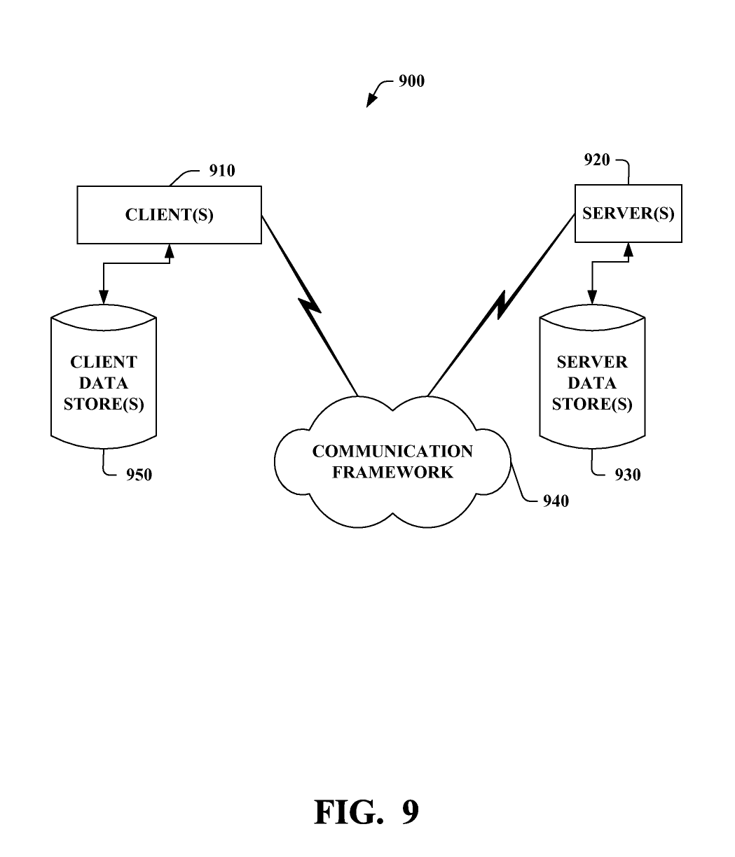

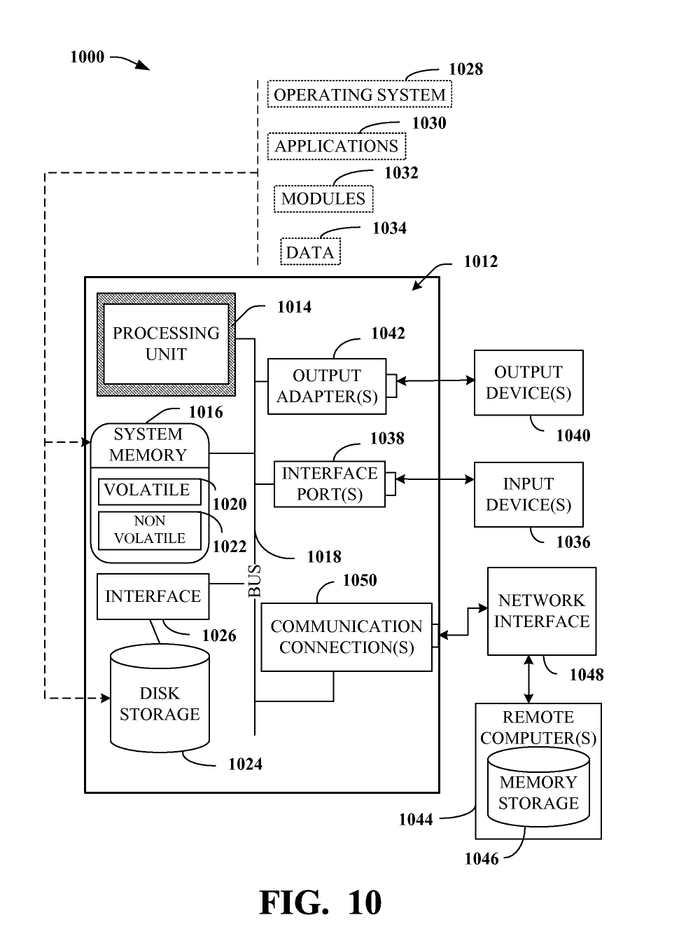

In order to provide additional context for implementing various aspects of the claimed subject matter, FIGS. 9-10 and the following discussion is intended to provide a brief, general description of a suitable computing environment in which the various aspects of the subject innovation may be implemented. For example, a viral coupon component that leverages a social network connection or relationship to discretely deliver coupons based upon friend referrals for business or service, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (JSB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates enhancing coupon distribution in a non-evasive manner based upon a referral, comprising:
a social network that includes two or more users with at least one actively acknowledged connection that indicates a relationship between a first user and a second user;
the two or more users are at least one of an entity, the entity is at least one of a web entity, a recommendation engine, a disparate user, a business, a group of users, a corporation, an enterprise, a machine, a website, or a partnership;
an interface that receives a referral from the first user associated with the social network, the referral describes an experience related to at least one of a business, a product, or a service;
a viral coupon component that implements a non-evasive delivery of a coupon to the second user based upon leveraging the relationship between the first user and the second user, the coupon is incorporated within at least one of an advertisement or a listing; and
the viral coupon component delivery of the coupon is triggered based upon the second user actively investigating at least one of the business or the service.

2. The system of claim 1, the experience is at least one of a posting, a review, a portion of audio, a portion of text, a portion of video, a portion of blog, a critique, or a portion of a graphic.

3. The system of claim 1, the second user actively investigates at least one of the business or the service with at least one of a search engine, a search site, a web site, the Internet, a local search engine, a review site, an aggregation site, a product search site, a shopping website that includes a vendor, a shopping website that includes a product, an article, a newspaper, a book, a magazine, a customized portion of print, a customized portion of media, an on-demand book printing, a portion of embedded user-specific advertisement, or a product price finder engine.

4. The system of claim 1, the social network is at least one of a social networking site, a social networking web page, a communication application, a messaging application, an address book, a forum, an instant messaging application, or an online community.

5. The system of claim 1, the business provides for purchase at least one of a good, a product, a consumable item, a portion of software, a portion of an application, or a portion of data.

6. The system of claim 1, the viral coupon component distributes a referral reward from at least one of the business or the service to the first user based upon an exposure of the coupon to the second user.

7. The system of claim 1, the viral coupon component distributes a referral reward from at least one of the business or the service to the first user based upon a use of the coupon in a purchase between the second user and at least one of the business or the service.

8. The system of claim 1, the viral coupon component distributes a referral reward from at least one of the business or the service to the first user based upon submission of feedback.

9. The system of claim 1, the coupon is at least one of a printable coupon that is at least one of the following:
redeemable within a physical store;
an electronic coupon that is redeemable within an online store on the Internet; or
an electronic coupon distributed to a mobile device for redemption within the physical store.

10. The system of claim 9, the coupon bridges an online advertisement with offline services to enable a charge-per-action model of advertisement to be extended from an online transaction to an offline transaction in the real world.

11. The system of claim 1, the viral coupon component enables the second user to access to the referral from within the social network.

12. The system of claim 11, the viral coupon component aggregates the referral within information associated with a respective user's social network information.

13. The system of claim 1, the viral coupon component communicates the coupon to a device.

14. The system of claim 13, the device is at least one of a machine, a computer, a smartphone, a cellular device, a portable digital assistant (PDA), a gaming device, a mobile gaming device, a media player, a portable media device, a mobile device; a non-electronic device, a credit card, an identification card, a gift card, a card including a chip, or a card having a magnetic strip.

15. The system of claim 1, the coupon includes at least one of a human identifier, a machine-readable identifier, a portion of data related to cryptography, a portion of data related to elliptic curve cryptography (ECC), a portion of data related to public key, or a portion of data related to a digital signature.

16. The system of claim 15, the coupon is employed to resolve a dispute associated with a purchase with at least one of the business or the service, the dispute is associated with at least one of a purchase or a referral award due to a purchase.

17. A computer-implemented method that facilitates leveraging relationships within a social network to provide referrals, coupons, and referral rewards between users, comprising:
actively establishing a connection between a first user and a second user within a social network;
receiving a referral for at least one of a business, a product, or a service from the first user;
identifying a search from the second user associated with at least one of the business, the product, or the service;
incorporating a coupon with a result from the search for the second user based at least in part upon the connection between the first user and the second user; and
delivering a referral bonus to the first user upon employment of the coupon by the second user.

18. The method of claim 17, further comprising:
aggregating the referral from the first user for at least one of the business, the product, or the service;
emphasizing the result to indicate existence of the coupon triggered by the referral from the first user;
enabling the coupon to be utilized in at least one of an online environment or an offline environment; and
communicating the coupon to a device.

19. The method of claim 17, the coupon bridges an online advertisement with offline services to enable a charge-per-action model of advertisement to be extended from an online transaction to an offline transaction in the real world.

20. A computer-implemented system that facilitates distributing a coupon in a non-evasive manner, comprising:
means for interacting between two or more users in a social network, the two or more users include an actively acknowledged connection indicating a relationship between a first user and a second user;
means for receiving a referral from the first user associated with the social network, the referral describes an experience related to at least one of a business or a service;
means for implementing a non-evasive delivery of a coupon to the second user based upon leveraging the relationship between the first user and the second user;
means for incorporating the coupon within at least one of an advertisement or a listing;
means for delivering the coupon triggered by the second user actively investigating at least one of the business or the service;
means for redeeming the coupon within at least one of a physical store in the real world or an online store on the Internet;
means for bridging an online advertisement with offline services with the coupon to enable a charge-per-action model of advertisement to be extended from an online transaction to an offline transaction in the real world; and
means for communicating the coupon to a device.
